(19) United States
(12) Patent Application Publication
(10) Pub. No.: US 2010/0307225 A1
(43) Pub. Date: Dec. 9, 2010

(54) METHOD FOR TESTING FOR THE PRESENCE OF A LEAK HOLE IN A FLUID CONTAINER

(76) Inventor: Kengo Yoshida, Kanagawa-ken (JP)

Correspondence Address: BIRCH STEWART KOLASCH & BIRCH, PO BOX 747, FALLS CHURCH, VA, 22040-0747, US

(21) Appl. No.: 12/864,524

(22) PCT Filed: Jan. 27, 2009
(86) PCT No.: PCT/JP2009/051275

§ 371 Date: Jul. 26, 2010

(30) Foreign Application Priority Data
Jan. 27, 2008 (JP) 2008-043576
Nov. 2, 2008 (JP) 2008-305487

(51) Int. Cl. G01M 3/24

(52) U.S. Cl. 73/40.5 A

(57) ABSTRACT

The present invention provides an excellent method for detecting a leak hole, the method being advantageous in: that a leak hole can be surely detected when any fluid present in the outside of a tank is caused, by internal decompression of the tank, to infiltrate into any fluid in the inside of the tank through the leak hole; that any leak hole present at any portion of the entire structure of a tank can be detected; and that the required testing time can be greatly shortened.

The method comprises: (1) closing a mouth of a container containing a fluid, (2) adjusting at least one of the internal pressure and external pressure of the container so that the internal pressure of the container is lower than the external pressure of the container, and applying a reference ultrasonic signal having a predetermined phase to the fluid contained in the container, to thereby obtain a contained fluid ultrasonic signal, and (3) comparing the reference ultrasonic signal and the contained fluid ultrasonic signal with each other, wherein, when the contained fluid ultrasonic signal has a phase difference from the reference ultrasonic signal, and the phase difference continues to increase with the lapse of time, the container is judged to have a leak hole.

### FIELD OF THE INVENTION

The present invention relates to a method for testing for the presence of a leak hole in a fluid container. More particularly, the present invention is concerned with a method for testing for the presence of a leak hole in a fluid container, comprising: (1) closing a mouth of a container containing a fluid, (2) adjusting at least one of the internal pressure and external pressure of the container so that the internal pressure of the container is lower than the external pressure of the container, and applying a reference ultrasonic signal having a predetermined phase to the fluid contained in the container, to thereby obtain a contained fluid ultrasonic signal, and (3) comparing the reference ultrasonic signal and the contained fluid ultrasonic signal with each other, wherein, when the contained fluid ultrasonic signal has a phase difference from the reference ultrasonic signal, and the phase difference continues to increase with the lapse of time, the container is judged to have a leak hole. The method of the present invention is advantageous not only in that the presence or absence of a leak hole in a fluid container can be determined extremely precisely and rapidly, but also in that the method of the present invention is substantially insusceptible to the environmental conditions of the fluid container (e.g., whether the container is of an aboveground type or an underground type, the type of a liquid and/or a gas which is present around the container, and whether or not noises and/or vibrations are present around the container), thereby enabling the presence or absence of a leak hole in the fluid container to be surely determined in any environment. Therefore, the method of the present invention has very high reliability and very high efficiency. By the method of the present invention, a testing for the presence of a leak hole can be performed with high precision and high efficiency with respect to a wide variety of containers of various volumes, dimensions and shapes employed in various fields of industry, the containers ranging from a small size container (e.g., a container of about a 1-liter volume) which can be placed on the palm, to a gigantic container (e.g., a container of about a 15,000-kiloliter volume) which is generally called a “tank”. The present invention is also concerned with a system which can be used for practicing the method of the present invention.

### BACKGROUND OF THE INVENTION

There are containers used for accommodating a hazardous material, and some of such containers are legally required to be subjected to leak hole testing. Representative examples of such containers which are legally required to be subjected to leak hole testing include a stationary container structure and a mobile container structure. Specific examples of stationary container structures include an aboveground tank for containing only a gas, and an underground tank which is buried in the underground of a gas station (gasoline station), wherein the underground tank involves most complex factors and hence requires a high level technology of leak hole testing, thus posing many problems. Specific examples of mobile container structures include tanks carried on tank lorries. Of these tanks, generally the most representative types of tanks are an underground tank which is buried in the underground of a gas station, and a tank carried on a tank lorry. (In the present invention, the term “container” and the term “tank” have the same meaning.)

A fact which is common to the above-mentioned two most representative types of tanks is that, in the use of any of these two types of tanks, the inside of the tank has both a gas phase and a liquid phase. When a liquid, such as petroleum oil, is introduced into a container, the introduction is generally performed so that the introduced oil (liquid phase) occupies at most about 80 to 95% of the internal volume of the container so that a gas phase (comprising air and gasified petroleum oil) occupying the remainder of the internal volume of the container remains above the liquid phase. When a container is filled with a liquid in an incomplete fashion, a gas phase necessarily remains in the inside of the container. The reason why the filling of a container with a liquid (such as petroleum oil) is generally performed in an incomplete fashion, is mainly safety.

A leak hole causes a leakage from a container. A leak hole is a through-hole (including a gap in a joint, a crack and the like) which is present in the structure of a container. A leak hole may occur at any portion of a container, such as a wall portion, an inlet portion, an exhaust pipe. Therefore, when a fluid (such as a gas or a liquid (e.g., water or oil)) which is present in the outside of a container infiltrates into the container through a leak hole present in the container, the fluid may flow into any of the gas phase and liquid phase of the inside of the container. Further, when a container has a plurality of leak holes or has a crack as a leak hole, a fluid may flow into both of the gas phase and liquid phase of the inside of the container.

A fluid present in the outside of an above-ground tank is a gas, such as air. Therefore, in the case where an aboveground tank contains only a gas or an aboveground tank is empty, when the tank has a leak hole therein, an outside gas (such as air) flows into the gas single phase of the inside of the tank through the leak hole.

As mentioned above, most representative types of tanks are an underground tank which is buried in the underground of a gas station, and a tank carried on a tank lorry. Of these two types of tanks, the more representative is the former, i.e., an underground tank which is buried in the underground of a gas station. Therefore, hereinafter, the explanations will be made referring to an underground tank which is buried in the underground of a gas station.

Unexamined Japanese Patent Application Laid-Open Specification No. 2005-265469 (Patent Document 1) discloses a method for testing for the presence of a leak hole in an underground tank of a gas station or the like, in which the inside of a tank is decompressed, thereby causing air or the like present around the tank to flow into a liquid contained in the tank through a leak hole and form gas bubbles therein, and the resultant vibration of rupture of the bubbles is detected by means of an acceleration sensor. However, in this method, when a leak hole in an underground tank, buried in the underground, has its outer opening positioned close to a liquid (such as rain water, underground water or oil) present around the underground tank, such liquid is caused to flow into the decompressed inside of the tank, so that gas bubbles are not formed, and hence rupture of bubbles does not occur. Thus, in this case, this method cannot detect the presence of a leak hole.

Unexamined Japanese Patent Application Laid-Open Specification No. 2006-29835 (Patent Document 2) discloses a method for testing for the presence of a leak hole in an underground tank of a gas station or the like, in which the inside of a tank is decompressed, thereby causing air or the like present around the tank to flow into a liquid in the tank through a leak hole, and the resultant sound of gas flow into the liquid present in the tank is detected by means of a highly sensitive sensor and by performing an operation using a noise processing software. However, in this method, when a liquid present around the underground tank is caused to flow into the liquid present in the tank, the sound of liquid flow into the liquid present in the tank cannot be detected.

Thus, any of the methods of the above-mentioned Patent Document 1 and Patent Document 2 poses a problem in that, when a liquid present around a tank is caused to infiltrate into the tank through a leak hole, the infiltration of the liquid into the tank cannot be detected. The reason for this problem is as follows. The amount of a liquid which infiltrates into the tank through a very small leak hole which is required to be detected, i.e., a leak hole having a diameter of 0.3 mm, is extremely small because of the surface tension of the liquid and the like. Also, the speed of the infiltration of the liquid into the tank is very low. Further, even after the infiltrating liquid comes out of the inner opening of the leak hole into the inside of the tank, the extremely small amount of liquid falls very slowly along and in contact with the inner surface of the tank, until the liquid very slowly falls into the liquid phase in the tank. When an extremely small amount of a liquid infiltrates slowly into the inside of a tank, the liquid does not generate a detectable sound, irrespective of whether the liquid flows into a liquid phase or a gas phase in the tank, so that a leak hole cannot be detected.

For this reason, each of these methods of Patent Document 1 and Patent Document 2 is qualified as a latest technology of leak hole testing method and employed in the art, on the condition that the leak hole testing method should be used in combination with a latest method for water level detection, in which infiltration of water is detected (see Unexamined Japanese Patent Application Laid-Open Specification No. 2006-30109 (Patent Document 3)).

However, anyway, any of these methods of Patent Document 1 and Patent Document 2 has a problem in that, when a gas present in the outside of a tank infiltrates into the tank through a leak hole therein which has its inner opening positioned in contact with a gas phase (comprising air and a gasified fuel) present in the upper portion of the inside of the tank, the infiltration of the gas cannot be detected because almost no acoustic vibration is generated by such gas infiltration into the gas phase in the tank. Needless to say, it is necessary to detect a leak hole having its inner opening positioned in contact with a gas phase of the inside of the tank. Therefore, in the art, it is legally required that, in addition to any of these methods of Patent Document 1 and Patent Document 2, there should also be used a method which can detect the infiltration of an outside gas into a gas phase of the inside of the tank. More specifically, it is legally required to additionally perform a leak hole testing based on a “micro-decrease-in-pressure” method or “micro-increase-in-pressure” method in which a pressure change of the inside of a tank is detected (see, for example, Unexamined Japanese Patent Application Laid-Open Specification No. Hei 5-10845 (Patent Document 4)). This leak hole testing (based on a “micro-decrease-in-pressure” method or “micro-increase-in-pressure” method) is a method generally employed for a leak hole testing of a tank carried on a tank lorry and for a leak hole testing of a general-purpose fluid container.

Further, the above-mentioned latest method for water level detection (i.e., the method of Patent Document 3), which is used in combination with each of the methods of Patent Document 1 and Patent Document 2, has a problem in that this method employs a water level sensor which cannot detect a petroleum oil; therefore, when a leak hole in a tank has its outer opening positioned close to an oil present around the tank, and such oil is caused to flow into the inside of the tank through the leak hole, the infiltrating oil cannot be detected by the water level sensor, so that the leak hole cannot be detected.

When a tank of a gas station has a leak hole therein, a part of an oil (such as gasoline) which has been stored in the tank for a long period of time, has already leaked to the outside of the tank through the leak hole, so that the leak hole (of a diameter of several millimeters or less, e.g., 0.3 mm) which should be detected has its outer opening positioned in close contact with a pool of leaked oil which is more viscous than water, and hence, no water or air is in contact with the outer opening of such leak hole. Such condition is believed to very frequently occur around the outer opening of a leak hole. In the case of such condition, any of the conventional leak hole testing methods which are currently qualified as the latest methods, poses a problem as follows. When the inside of the tank is decompressed for the purpose of leak hole detection, an outside oil which is the same as in the tank is inevitably caused to go back and infiltrate into the inside of the tank through the leak hole. The infiltrating oil and stored oil cannot be easily distinguished from each other and are likely to easily mix with each other. There is no conventional method which can detect the infiltration of an oil which is the same as in the tank. Therefore, with respect to the conventional leak hole testing methods, it is generally considered that the detection ratio of leak holes in underground tanks is very low.

Thus, any of the methods of Patent Document 1 and Patent Document 2 has the above-described problem. Further, as also described above, with respect to the leak hole testing of an underground tank, in addition to a testing using any of the methods of Patent Document 1 and Patent Document 2, it is also required that the presence or absence of a leak hole having its inner opening positioned in contact with a gas phase of the inside of the tank, be detected by a testing method based on the “micro-decrease-in-pressure” method or “micro-increase-in-pressure” method. Furthermore, it is considered that a leak hole is most likely to occur in the bottom portion of an underground tank, because the bottom portion of an underground tank is likely to suffer abrasion, damage and the like. Nevertheless, as mentioned above, it is generally considered that the detection ratio of leak holes in underground tanks is very low. This is a very great problem, and it has been strongly desired to solve this problem.

Among the above-mentioned conventional leak hole testing methods, there is almost no difference in the required testing time, irrespective of whether the method is for detecting a leak hole in a tank carried on a tank lorry and a leak hole in a general-purpose fluid container (wherein these tank and container are only required to be inspected for detecting a leak hole having its inner opening positioned in contact with a gas phase of the inside of the tank, by using the “micro-decrease-in-pressure” method or “micro-increase-in-pressure” method), or the method is for detecting a leak hole in an underground tank. In the case of any of the above-mentioned conventional leak hole testing methods, the required testing time is as long as about 80 minutes to about 180 minutes.

Especially in the case where a leak hole testing is performed for a gas station having a plurality of tanks, it is necessary to closedown the gas station for a long time until the leak hole testing of all tanks has been completed. Further, when such leak hole testing is performed using not only the above-mentioned method of Patent Document 1 or Patent Document 2, but also the above-mentioned water level detection method and the above-mentioned “micro-decrease-in-pressure” method or “micro-increase-in-pressure” method, the required testing time would be tripled, relative to the case of a leak hole testing using only the method of Patent Document 1 or Patent Document 2. Such required long testing time is a great problem for the operation of a gas station.

Thus, the conventional technology for a leak hole testing of an underground tank of a gas station or the like still has many problems. It has been strongly desired to develop a leak hole testing method which can solve these problems. Further, if a rapid and highly reliable method for detecting a leak hole in an underground tank is developed, it also becomes possible to easily detect a leak hole in various aboveground tanks.

### Patent Document 1: Unexamined Japanese Patent Application Laid-Open Specification No. 2005-265469.

### Patent Document 2: Unexamined Japanese Patent Application Laid-Open Specification No. 2006-29835.

### Patent Document 3: Unexamined Japanese Patent Application Laid-Open Specification No. 2006-30109.

Patent Document 4: Unexamined Japanese Patent Application Laid-Open Specification No. Hei 5-10845.

### DISCLOSURE OF THE INVENTION

### Problems to Be Solved by the Invention

As described hereinabove, it has been desired to provide an excellent method, system or the like for detecting a leak hole, the method or system being advantageous in: that the method or system can solve the conventional problem of inability to detect the infiltration of an oil into the inside of a tank; that the method or system is completely insusceptible to the environmental conditions, such as whether a fluid present in the outside of a tank is a gas or a liquid or water or an oil; that a leak hole can be surely detected without any problem when any fluid present in the outside of a tank is caused, by internal decompression of the tank, to infiltrate into any fluid in the inside of the tank through the leak hole; that any leak hole present at any portion of the entire structure of a tank can be detected; and that the required testing time can be greatly shortened.

### Means to Solve the Problems

In this situation, the present inventor has made extensive and intensive studies with a view toward solving the above-mentioned problems. As a result, he has unexpectedly found that the above-mentioned problems can be solved by a method for testing for the presence of a leak hole in a fluid container, comprising: (1) closing a mouth of a container containing a fluid, (2) adjusting at least one of the internal pressure and external pressure of the container so that the internal pressure of the container is lower than the external pressure of the container, and applying a reference ultrasonic signal having a predetermined phase to the fluid contained in the container, to thereby obtain a contained fluid ultrasonic signal, and (3) comparing the reference ultrasonic signal and the contained fluid ultrasonic signal with each other, wherein, when the contained fluid ultrasonic signal has a phase difference from the reference ultrasonic signal, and the phase difference continues to increase with the lapse of time, the container is judged to have a leak hole. The present invention has been completed, based on this finding.

The foregoing and other objects, features and advantages of the present invention will be apparent from the following detailed description taken in connection with the accompanying drawings, and the appended claims.

### EFFECTS OF THE INVENTION

In the prior art, the detection ratio of leak holes in the bottom portions of underground tanks is very low, although it is considered that a leak hole is most likely to occur in the bottom portion of an underground tank. By the method of the present invention, the infiltration of an oil into the inside of a tank can be surely detected, thereby enabling a leak hole in the bottom portion of an underground tank to be surely detected. Therefore, the method of the present invention has for the first time fully attained the object of the legally required leak hole testing of a tank, thereby making a great contribution to the safety of public society in respect of the handling of dangerous substances.

The testing method of the present invention is advantageous not only in that the presence or absence of a leak hole in a fluid container can be determined extremely precisely and rapidly, but also in that the method of the present invention is substantially insusceptible to the environmental conditions of the fluid container (e.g., whether the container is of an above-ground type or an underground type, the type of a liquid and/or a gas which is present around the container, and whether or not noises and/or vibrations are present around the container), thereby enabling the presence or absence of a leak hole in a fluid container to be surely determined in any environment. Therefore, the method of the present invention has very high reliability and very high efficiency. By the method of the present invention, a testing for the presence of a leak hole can be performed with high precision and high efficiency with respect to a wide variety of containers of various volumes, dimensions and shapes employed in various fields of industry, the containers ranging from a small size container (e.g., a container of about a 1-liter volume) which can be placed on the palm, to a gigantic container (e.g., a container of about a 15,000-kiloliter volume) which is generally called a “tank”.

### BRIEF DESCRIPTION OF THE DRAWINGS

FIG. 1 shows an example of an operation in which the method and system of the present invention are practiced on an underground tank of a gas station.

FIG. 2 gives photographs showing the occurrence of a phase delay (phase difference) employed in the testing method of the present invention.

FIG. 3 gives photographs showing an operation in which the wavelength of a reference ultrasonic signal is adjusted in accordance with the diameter of a leak hole to be detected, thereby adjusting the amplitude of the ultrasonic signal of a fluid which infiltrates through the leak hole into the container so as to maximize the detection precision for the leak hole.

FIG. 4 shows a picture sequence of the display of an oscilloscope showing an example of measurement results obtained in the testing method of the present invention (leak hole diameter: 1.0 mm).

FIG. 5 shows a picture sequence of the display of an oscilloscope showing another example of measurement results obtained in the testing method of the present invention (leak hole diameter: 0.3 mm).

FIG. 6 shows a picture sequence of the display of an oscilloscope showing still another example (in which a phase inversion occurs) of measurement results obtained in the testing method of the present invention (leak hole diameter: 1.0 mm).

FIG. 7 shows another example of an operation in which the method and system of the present invention are practiced on an underground tank of a gas station.

FIG. 8 shows still another example of an operation in which the method and system of the present invention are practiced on an underground tank of a gas station, and also shows that a combination of the wavelength (frequency) and waveform of a signal can be automatically adjusted while observing the signal waveform by means of a microcomputer.

FIG. 9 gives photographs showing differences in phase and waveform between a contained fluid ultrasonic signal obtained in a case where air infiltrates through a leak hole (diameter: 0.3 mm) into a small container (FIG. 9(A)), and a contained fluid ultrasonic signal obtained in a case where a strong impact is intentionally applied to a small container having no leak hole (FIG. 9(B)).

FIG. 10 shows operations in which experiments and measurements concerning the present invention are performed using a method which has been conventionally appreciated for good performance in adjustment and evaluation of a leak hole testing system. FIG. 10(A) shows an example of a method for adjusting the wavelength or the like of a reference ultrasonic signal in accordance with the diameter of a leak hole to be detected. FIG. 10(B) shows a method for evaluating the method of the present invention with respect to a case where only a small amount of a liquid resides in the outside of a container, and all residing liquid is present just around an outer opening of a leak hole. FIG. 10(C) shows a method for evaluating the method of the present invention with respect to a case where a large part of the outer surface of an underground tank is placed in contact with a residing fluid, such as in the case of a coastal area, a river front or the like. FIG. 10(D) shows simulated leak holes used for evaluation of a leak hole testing method.

### DESCRIPTION OF REFERENCE NUMERALS

1 Reference ultrasonic signal
2 Ultrasonic signal emitting element
3 Contained fluid ultrasonic signal
3a Contained fluid ultrasonic signal of a liquid phase
3b Contained fluid ultrasonic signal of a gas phase
4 Ultrasonic signal detecting element
5 Pressure value control means
6 Residing fluid around a container (tank)
7 Fluid infiltrating through a leak hole (or an ultrasonic signal of such fluid)
8 Container (tank)
9 Leak hole
10 Electronic processing means for generation and processing of electrical signals
11 Underground manhole
12 Underground pipe

### BEST MODE FOR CARRYING OUT THE INVENTION

In one aspect of the present invention, there is provided a method for testing for the presence of a leak hole in a fluid container, comprising:

(1) closing a mouth of a container containing at least one fluid selected from the group consisting of a liquid and a gas,

(2) adjusting at least one of the internal pressure and external pressure of the container so that the internal pressure of the container is lower than the external pressure of the container, and applying a reference ultrasonic signal having a predetermined phase to the fluid contained in the container, to thereby obtain a contained fluid ultrasonic signal, and

(3) comparing the reference ultrasonic signal and the contained fluid ultrasonic signal with each other, wherein, when the contained fluid ultrasonic signal has a phase difference from the reference ultrasonic signal, and the phase difference continues to increase with the lapse of time, the container is judged to have a leak hole.

In another aspect of the present invention, there is provided a system for testing for the presence of a leak hole in a fluid container, comprising:

a pressure value control means for adjusting at least one of the internal pressure and external pressure of the container so that the internal pressure of the container is lower than the external pressure of the container,

at least one ultrasonic signal emitting element disposed in at least one position selected from the group consisting of the outside and inside of the container,

at least one ultrasonic signal detecting element disposed in at least one position selected from the group consisting of the outside and inside of the container, and

an electronic processing means for generation and processing of electrical signals, the electronic processing means being connected to the at least one ultrasonic signal emitting element and the at least one ultrasonic signal detecting element.

For easier understanding of the present invention, the essential features and various preferred embodiments of the present invention are enumerated below.

1. A method for testing for the presence of a leak hole in a fluid container, comprising:

(1) closing a mouth of a container containing at least one fluid selected from the group consisting of a liquid and a gas,

(2) adjusting at least one of the internal pressure and external pressure of the container so that the internal pressure of the container is lower than the external pressure of the container, and applying a reference ultrasonic signal having a predetermined phase to the fluid contained in the container, to thereby obtain a contained fluid ultrasonic signal, and

(3) comparing the reference ultrasonic signal and the contained fluid ultrasonic signal with each other, wherein, when the contained fluid ultrasonic signal has a phase difference from the reference ultrasonic signal, and the phase difference continues to increase with the lapse of time, the container is judged to have a leak hole.

2. The method according to item 1 above, wherein the reference ultrasonic signal is emitted using at least one ultrasonic signal emitting element disposed in at least one position selected from the group consisting of the outside and inside of the container, and wherein the contained fluid ultrasonic signal is detected using at least one ultrasonic signal detecting element disposed in at least one position selected from the group consisting of the outside and inside of the container.

3. The method according to item 1 or 2 above, wherein there is employed at least one measuring condition selected from the group consisting of the following measuring conditions (i) to (iii):

(i) the waveform of the reference ultrasonic signal is a sine wave;

(ii) the reference ultrasonic signal has a wavelength which is not smaller than the diameter of a smallest leak hole to be detected; and

(iii) in step (2), at least one of the internal pressure and external pressure of the container is adjusted so that the internal pressure of the container is at least 1 kPa lower than the external pressure of the container.

4. The method according to any one of items 1 to 3 above, wherein:

the container is an underground tank,

the fluid contained in the container comprises a liquid and a gas,

the liquid is a liquid fuel, and

the gas is a gaseous mixture of air and an evaporated fuel.

5. The method according to any one of items 1 to 3 above, wherein:

the container is an aboveground tank or an underground tank, and

the fluid contained in the container is a gaseous fuel.

6. A system for testing for the presence of a leak hole in a fluid container, comprising:

a pressure value control means for adjusting at least one of the internal pressure and external pressure of the container so that the internal pressure of the container is lower than the external pressure of the container,

at least one ultrasonic signal emitting element disposed in at least one position selected from the group consisting of the outside and inside of the container,

at least one ultrasonic signal detecting element disposed in at least one position selected from the group consisting of the outside and inside of the container, and

an electronic processing means for generation and processing of electrical signals, the electronic processing means being connected to the at least one ultrasonic signal emitting element and the at least one ultrasonic signal detecting element.

Hereinbelow, the present invention is described in detail.

The present inventor has found that when a fluid is fed to a container having a leak hole, a mouth of the container is closed, at least one of the internal pressure and external pressure of the container is adjusted so that the internal pressure of the container is lower than the external pressure of the container, a reference ultrasonic signal having a predetermined phase is applied to the fluid contained in the container to thereby obtain a contained fluid ultrasonic signal, and the reference ultrasonic signal and the contained fluid ultrasonic signal are compared with each other, the contained fluid ultrasonic signal has a phase difference from the reference ultrasonic signal, and the phase difference continues to increase with the lapse of time. The present inventor has also found that when the same operation as mentioned above is performed to a container having no leak hole, the contained fluid ultrasonic signal has a phase difference from the reference ultrasonic signal, but the phase difference remains constant and never increases with the lapse of time. Therefore, whether the container has a leak hole can be judged simply by determining whether the contained fluid ultrasonic signal has the feature that the contained fluid ultrasonic signal has a phase difference from the reference ultrasonic signal, and the phase difference continues to increase with the lapse of time. This quite unexpected fact has for the first time been found by the present inventor, and is the basis of the present invention. (Hereinafter, the above-mentioned feature that the contained fluid ultrasonic signal has a phase difference from the reference ultrasonic signal, and the phase difference continues to increase with the lapse of time, is frequently referred to as “phase difference feature”.)

In step (1) of the method of the present invention for testing for the presence of a leak hole in a fluid container, a mouth of a container containing at least one fluid selected from the group consisting of a liquid and a gas is closed.

In the present invention, a “fluid container” refers not only to a container exclusively used for accommodating a fluid, but also to any container which is to be fluid-tightly sealed. Therefore, the method of the present invention can also be applied, for example, to a container for accommodating a solid material, wherein the container is fluid-tightly sealed in the use thereof. In the present invention, a “leak hole” refers to a through-hole, crack or the like which has unintentionally occurred and through which the inside and outside of the container communicate with each other even when the mouth of the container is closed. With respect to the size of a leak hole, there is no particular limitation, but a leak hole generally has a diameter of about 0.1 mm or more.

With respect to at least one fluid selected from the group consisting of a liquid and a gas in step (1) of the method of the present invention, there is no particular limitation. Non-limited examples of liquids include water, a liquid fuel, an alcohol and a liquid mixture thereof. Non-limited examples of gases include air, an inert gas, a gaseous fuel, a gas obtained by evaporation of a liquid fuel, and a gaseous mixture thereof.

In step (2) of the method of the present invention, at least one of the internal pressure and external pressure of the container is adjusted so that the internal pressure of the container is lower than the external pressure of the container, and a reference ultrasonic signal having a predetermined phase is applied to the fluid contained in the container, to thereby obtain a contained fluid ultrasonic signal. (Hereinafter, the operation for adjusting at least one of the internal pressure and external pressure of the container so that the internal pressure of the container is lower than the external pressure of the container is frequently referred to as “pressure adjustment operation”.)

With respect to the pressure adjustment operation performed in step (2) of the method of the present invention, there is no particular limitation so long as the internal pressure of the container becomes lower than the external pressure of the container by the operation. For example, the internal pressure of the container may be reduced by the operation. Alternatively, the external pressure of the container may be elevated by the operation. Further, the reduction of the internal pressure of the container and the elevation of the external pressure of the container may be simultaneously performed by the operation. If the container has a leak hole, the pressure adjustment operation causes a fluid, such as air or a liquid fuel, present in the outside of the container to infiltrate into the container through the leak hole. The pressure adjustment operation can be performed as employed in conventional methods for testing for the presence of a leak hole in a container. For example, the pressure adjustment operation can be performed as employed in Patent Document 1 or 2, in which the inside of the container is decompressed.

In step (3) of the method of the present invention, the reference ultrasonic signal and the contained fluid ultrasonic signal are compared with each other, wherein, when the contained fluid ultrasonic signal has a phase difference from the reference ultrasonic signal, and the phase difference continues to increase with the lapse of time (that is, the contained fluid ultrasonic signal has the above-mentioned phase difference feature), the container is judged to have a leak hole.

Although the expression “have a phase difference” is used in the phase difference feature, the expression “have a phase delay” is also frequently used in the present specification, because the phenomenon described as the phase difference feature can also be expressed as follows: the contained fluid ultrasonic signal has a phase delay from the reference ultrasonic signal.

The operation in step (2) of the method of the present invention of applying a reference ultrasonic signal having a predetermined phase to the fluid contained in the container, the operation in step (2) of the method of the present invention of obtaining a contained fluid ultrasonic signal, and the operation in step (3) of the method of the present invention of comparing the reference ultrasonic signal and the contained fluid ultrasonic signal with each other to determine whether the contained fluid ultrasonic signal has the phase difference feature, can be easily performed by a person having ordinary skill in the field of electronic and electric engineering. These operations are explained below in detail.

In the method of the present invention, the reference ultrasonic signal can be emitted using at least one ultrasonic signal emitting element disposed in at least one position selected from the group consisting of the outside and inside of the container, and the contained fluid ultrasonic signal can be detected using at least one ultrasonic signal detecting element disposed in at least one position selected from the group consisting of the outside and inside of the container. That is, in the method of the present invention, with respect to each of the ultrasonic signal emitting element used for emitting the reference ultrasonic signal and the ultrasonic signal detecting element used for detecting the contained fluid ultrasonic signal, the position in which the element is disposed can be selected with a high degree of freedom. When the ultrasonic signal emitting element or ultrasonic signal detecting element is disposed in the outside of the container, it is preferred that the element is disposed on the outer surface of the container or in the vicinity of the outer surface of the container. With respect to the specific position in the vicinity of the outer surface of the container, a position within about 10 m of the outer surface of the container is preferred, a position within about 5 m of the outer surface of the container is more preferred, and a position within about 2 m of the outer surface of the container is still more preferred. When an underground tank is used as the container, metal pipes, such as an inlet pipe, an exhaust pipe and a maintenance pipe, are securely fixed to the container, and solid materials, such as metal materials, have a very small transmission loss of ultrasonic wave. When an aboveground tank is used as the container, the distance of the above-mentioned elements from the outer surface of the container is preferably about 1 m or less. When the ultrasonic signal emitting element or ultrasonic signal detecting element is disposed in the inside of the container, the element may be disposed on the inner surface of the container, in the vicinity of the inner surface of the container or in the middle of the inside of the container. It is preferred that the ultrasonic signal detecting element used for detecting the contained fluid ultrasonic signal is disposed in the inside of the container. When the inside of the container has both a liquid phase and a gas phase, it is preferred that two or more ultrasonic signal detecting elements are used for detecting the contained fluid ultrasonic signal, so that ultrasonic signal detecting elements are contacted with both the liquid and gas phases of the inside of the container.

As mentioned above, a person having ordinary skill in the field of electronic and electric engineering can easily determine in step (3) of the method of the present invention whether the contained fluid ultrasonic signal has the phase difference feature. In a preferred embodiment of the method of the present invention, the determination can be made employing at least one measuring condition selected from the group consisting of the following measuring conditions (i) to (iii):

(i) the waveform of the reference ultrasonic signal is a sine wave;
(ii) the reference ultrasonic signal has a wavelength which is not smaller than the diameter of a smallest leak hole to be detected; and
(iii) in step (2), at least one of the internal pressure and external pressure of the container is adjusted so that the internal pressure of the container is at least 1 kPa lower than the external pressure of the container.
By employing at least one of measuring conditions (i) to (iii), the determination in step (3) of whether the contained fluid ultrasonic signal has the phase difference feature can be more easily performed.

With respect to the type of the fluid container to which the test method of the present invention is applied, and the type of the fluid contained in the container, there is no particular limitation. Representative examples of the combination of the container and the fluid include a case in which the container is an underground tank and the fluid contained in the container comprises both a liquid and a gas, wherein the liquid is a liquid fuel and the gas is a gaseous mixture of air and an evaporated fuel, and a case in which the container is an aboveground tank or an underground tank and the fluid contained in the container is a gaseous fuel. Examples of liquid fuels include petroleums, plant oils and alcohols. Examples of gaseous fuels include natural gas, petroleum gas and hydrogen gas. Further examples of liquids and gases include foods, pharmaceuticals, cosmetics and detergents.

As a system for practicing the method of the present invention for testing for the presence of a leak hole in a fluid container, the following system can be used:

a system for testing for the presence of a leak hole in a fluid container, comprising:

a pressure value control means for adjusting at least one of the internal pressure and external pressure of the container so that the internal pressure of the container is lower than the external pressure of the container,

at least one ultrasonic signal emitting element disposed in at least one position selected from the group consisting of the outside and inside of the container,

at least one ultrasonic signal detecting element disposed in at least one position selected from the group consisting of the outside and inside of the container, and

an electronic processing means for generation and processing of electrical signals, the electronic processing means being connected to the at least one ultrasonic signal emitting element and the at least one ultrasonic signal detecting element.

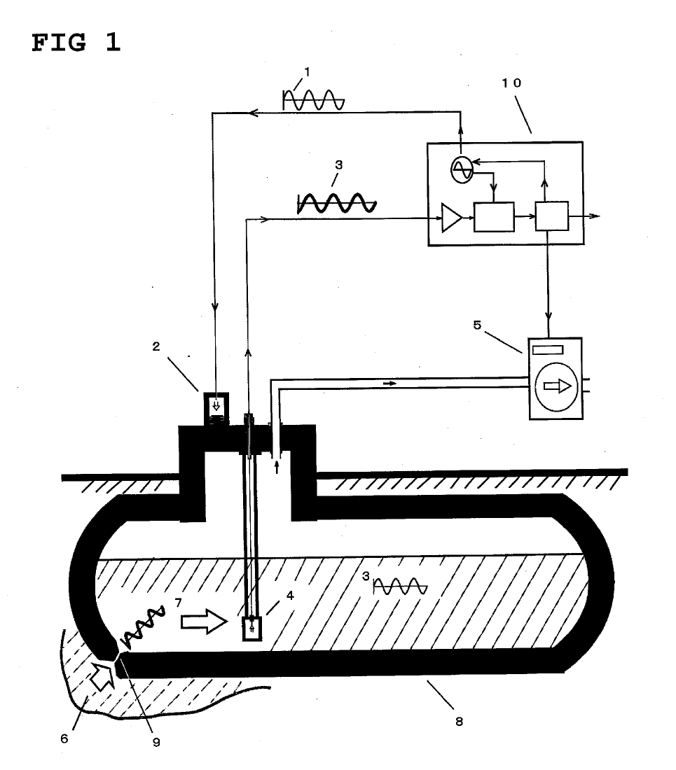

One example of such systems is shown in FIGS. 1, 7 and 8.

Hereinbelow, the present invention is explained in more detail by making reference to the appended drawings.

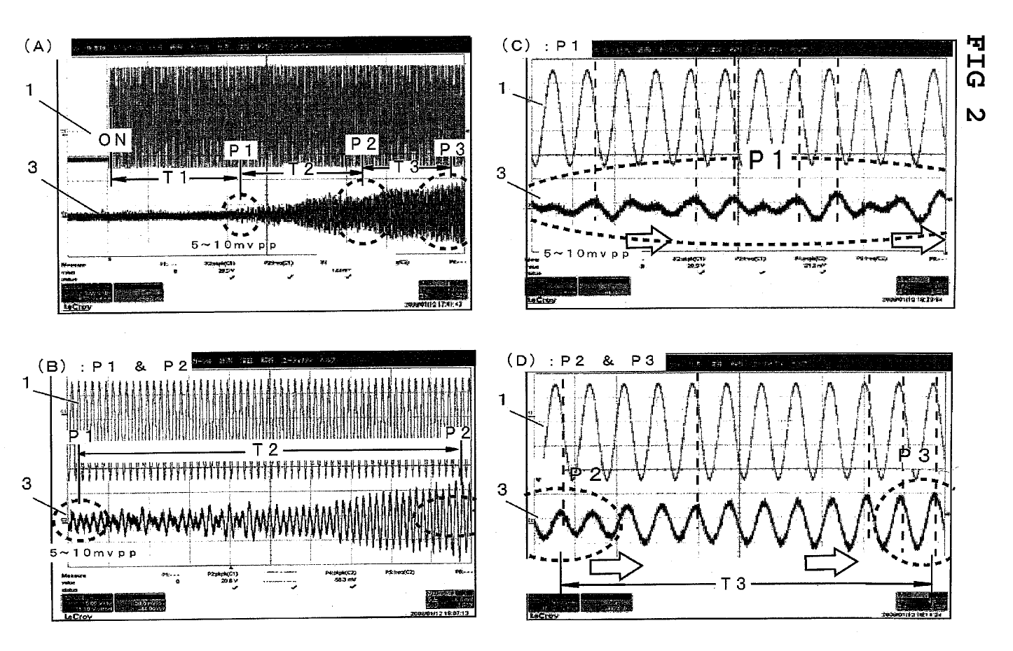

FIG. 2 gives photographs showing the occurrence of a phase delay (phase difference) employed in the testing method of the present invention. These photographs were taken by charging water (liquid phase) into a test tank (non-hermetically sealed and without leak holes) to obtain a fluid contained in the container, and applying reference ultrasonic signal 1 to the fluid, immediately followed by monitoring contained fluid ultrasonic signal 3 using an oscilloscope. The reference ultrasonic signal 1 emitted to the fluid contained in the container propagates through the fluid and causes a rise in the waveform of the contained fluid ultrasonic signal 3, wherein the phase of this waveform exhibits a continuous delay from the reference ultrasonic signal 1 (that is, phase difference continues to increase). This experiment is explained in detail below.

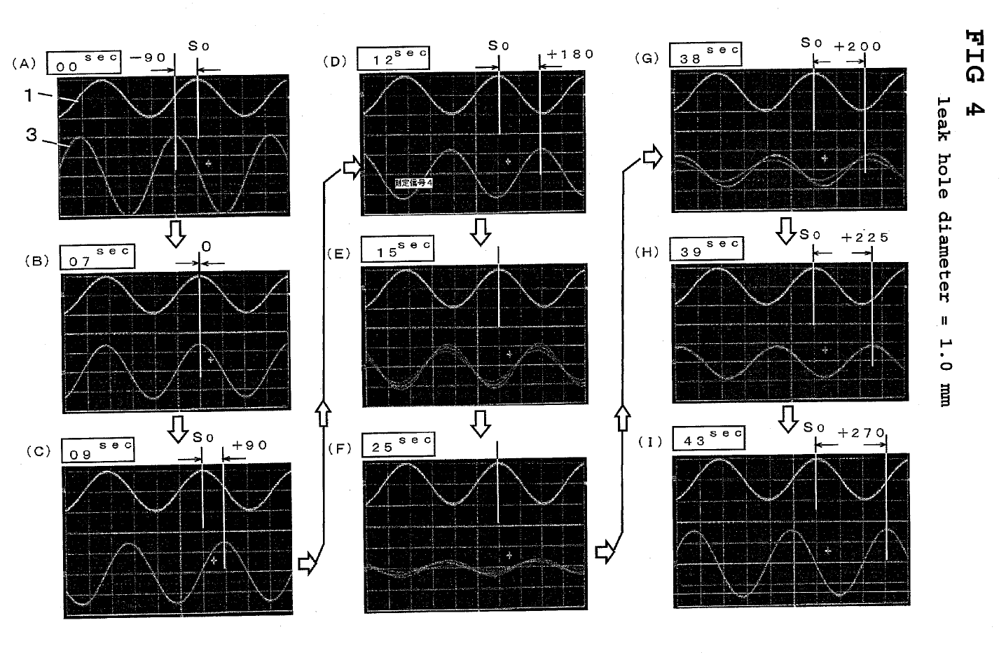

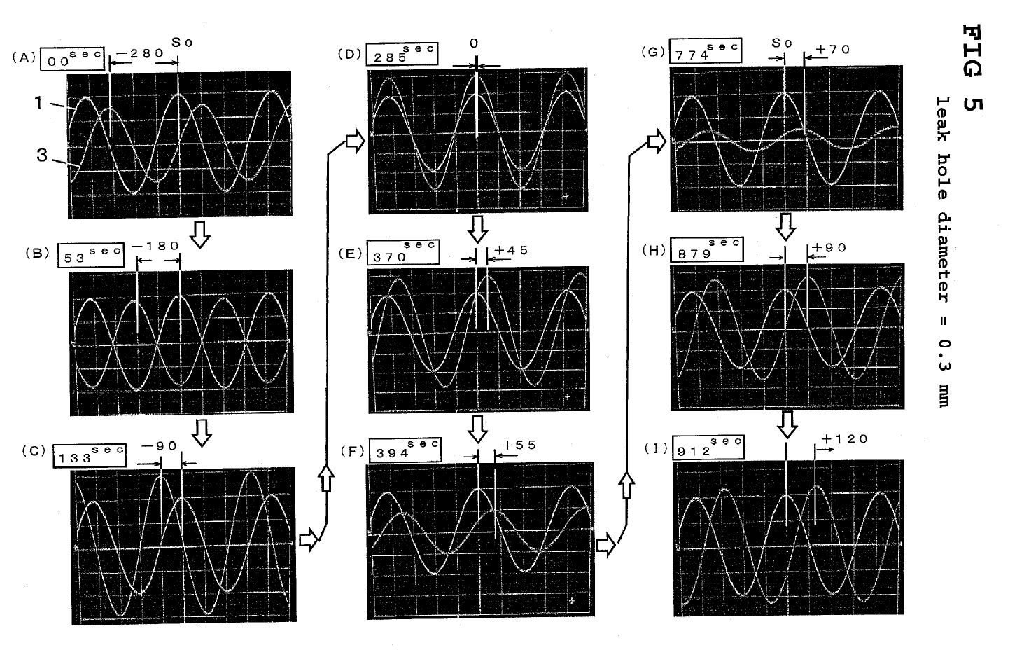

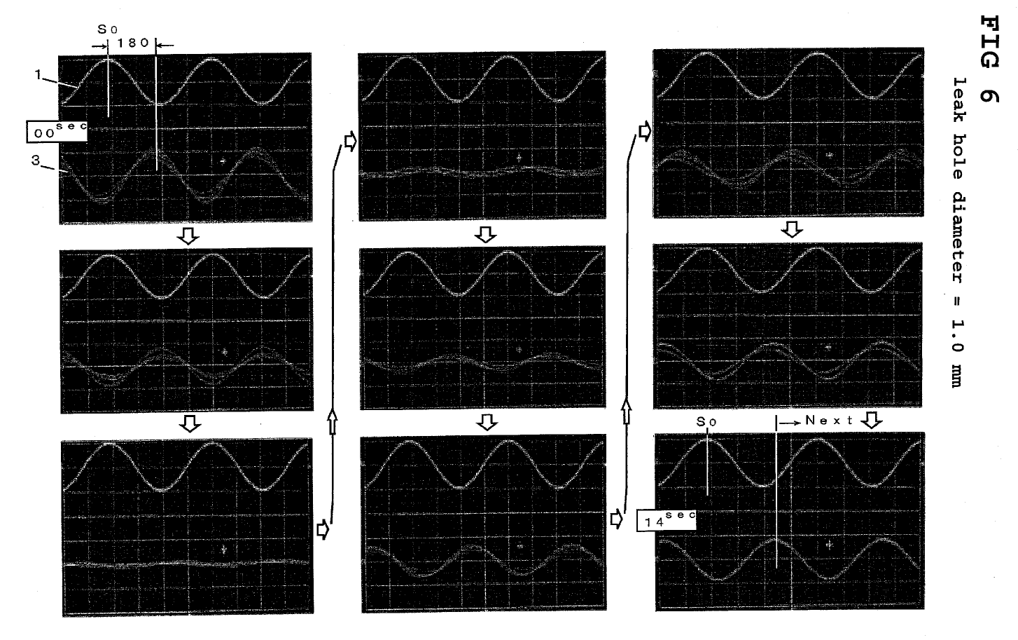

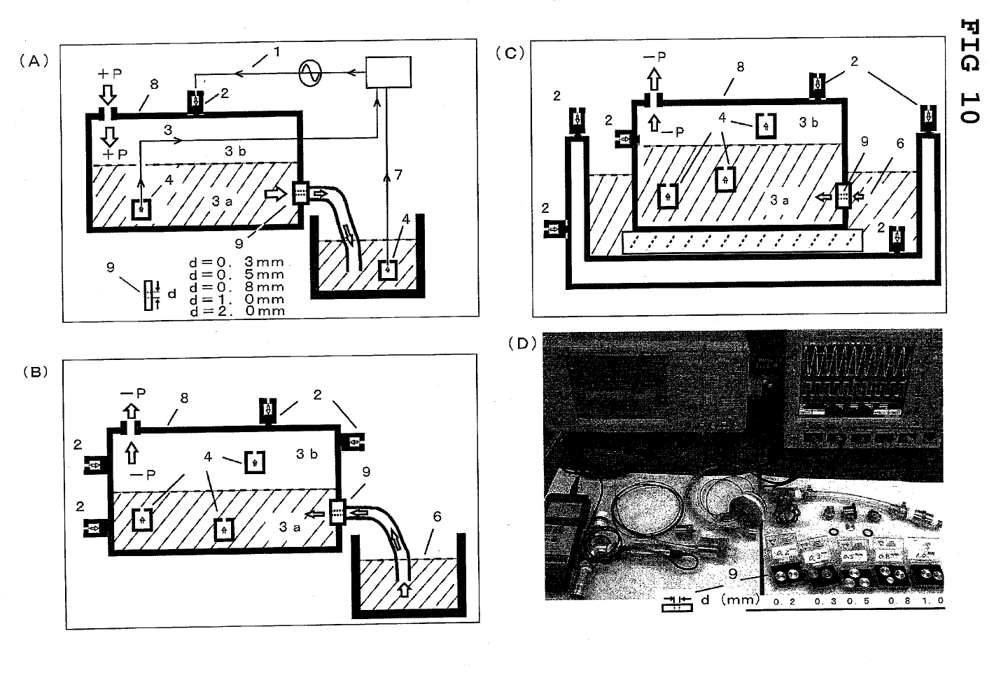

FIG. 10(B) and FIG. 10(C) show operations in which the method of the present invention is performed in the same manner as the actual test for leak hole 9 by using a tank for evaluation/experiment and simulated leak holes shown in FIG. 10(D) which are used for evaluation of a leak hole testing method. The display of the oscilloscope monitoring the experiment was continuously recorded by a video camera, and from the video image were prepared static images showing the phase difference feature. Each of FIG. 4, FIG. 5 and FIG. 6 was obtained by arranging the static images in accordance with the lapse of observation time. FIG. 4, FIG. 5 and FIG. 6 clearly demonstrate that the phase of the contained fluid ultrasonic signal 3 detected from the fluid contained in the container neither stabilizes nor ceases, while continuously increasing the phase difference from the reference ultrasonic signal 1 with the lapse of time (i.e., the phase difference feature appears); that a phase inversion occurs when the phase difference becomes about 90 to 180 degrees; and that the phase difference exceeds 180 degrees and approaches the subsequent 90 degree interval. This experiment is highly reproducible and the phase difference feature appears constantly and evidently in the case where the container 8 has leak hole 9. On the other hand, the phase difference feature is never observed in the case where the container 8 has no leak hole 9.

In the method of the present invention, the phase difference of the contained fluid ultrasonic signal 3 from the reference ultrasonic signal 1 is likely to increase with the lapse of the observation time. Such a phenomenon of continuously increasing phase difference is unlikely to occur easily under normal circumstances. It was also found that there is a correlation between the diameter of leak hole 9 and the time necessary for the phase difference to increase and reach a predetermined phase difference value. Accordingly, it is also possible to estimate the diameter of leak hole 9. For example, as apparent from FIG. 4 and FIG. 5, the time necessary for the phase difference to become 90 degrees is approximately 50 to 100 seconds when the diameter of the leak hole is 0.3 mm; whereas, the time necessary for the phase difference to become 90 degrees is approximately 4 to 8 seconds when the diameter of the leak hole is 1.0 mm. In other words, 3-fold increase in the diameter of the leak hole results in at least 10-fold increase in the time necessary for the phase difference to become 90 degrees. Based on such a correlation, the diameter of the leak hole can be measured from the time necessary for the phase difference to become 90 degrees, and a measurement in 0.1 mm unit is possible.

In step (3) of the method of the present invention, in the case where container 8 has leak hole 9, the phase difference feature can be detected from the contained fluid ultrasonic signal 3 within about 10 to 15 minutes from the start of the application of the reference ultrasonic signal 1 to the fluid contained in the container. On the other hand, in the case where the container has no leak holes, within a maximum of 1 second from the start of the application of the reference ultrasonic signal 1 to the fluid contained in the container, the contained fluid ultrasonic signal 3 becomes stationary while maintaining the phase difference from the reference ultrasonic signal 1 at a constant value and maintaining the amplitude at a stable value without fluctuation. Such conditions will be maintained stably and not even a hint of the phase difference feature is detected even after 72 hours or more. The occurrence of the phase difference feature in the contained fluid ultrasonic signal 3 is substantially insusceptible to vibrations from the outside or temperature change. Therefore, the possibility of the occurrence of an error in detecting the presence of the phase difference feature is very low.

The present invention is explained in more detail by making reference to FIG. 2. FIG. 2 shows photographs taken by charging water into a test tank (non-hermetically sealed and without leak holes), and applying the reference ultrasonic signal 1 to the water, immediately followed by the detection of the contained fluid ultrasonic signal 3 using an oscilloscope equipped with a storage memory. FIG. 2(A) is a profile showing the change in the contained fluid ultrasonic signal 3, wherein the waveform of the contained fluid ultrasonic signal 3 detected immediately after applying the reference ultrasonic signal 1 to the fluid begins to rise from a very small amplitude which is equivalent to that of noises, the waveform having unstable amplitude and phase keeps on developing to a point where the amplitude reaches a predetermined maximum value and, then, the phase of the waveform becomes constant and the waveform stabilizes. In FIG. 2(A), P1 represents “a region for initiating the use of the phase delay” which starts from the rising point of the waveform, P2 represents “a region where the waveform becomes stable and the phase delay continues until reaching P3”, P3 represents “a region which is almost synchronous”, T1 represents “a region starting from the emission of the reference ultrasonic signal and ending at the rise in the waveform of the fluid contained in the container”, and each of T2 and T3 represents a “phase delay region” (i.e., the region which can be used in the present invention). FIG. 2(B) is obtained by enlarging the displayed time axis of a portion marked T2 (phase delay region) in FIG. 2(A), wherein the enlargement is performed using the function of the storage memory of the oscilloscope. FIG. 2(C) is obtained by enlarging the displayed time axis of a portion marked P1 (waveform rising point) and circled with broken lines in FIG. 2(A), and FIG. 2(D) is obtained by enlarging the displayed time axis of a portion marked T3 (region between P2 and P3) in FIG. 2(A).

In FIG. 2(A), FIG. 2(B), FIG. 2(C) and FIG. 2(D), T2 and T3, each representing the time for the amplitude of the contained fluid ultrasonic signal 3 to reach a predetermined value, demonstrate that the phase of the contained fluid ultrasonic signal 3 continues to delay from the reference ultrasonic signal 1. Detailed inspection of the data shown in FIG. 2(C) reveals that when the phase difference from the reference ultrasonic signal 1 becomes at least 90 degrees, the amplitude of the contained fluid ultrasonic signal 3 decreases drastically; that when the phase difference becomes about 180 degrees, the waveform of the contained fluid ultrasonic signal 3 disappears almost completely; and that when the phase difference exceeds 180 degrees and approaches the subsequent 90 degrees interval, the waveform of new contained fluid ultrasonic signal 3 rises. Detailed observation on the data recorded by a video camera will reveal this phenomenon more clearly.

As shown in FIG. 2(A), there is a case where the contained fluid ultrasonic signal 3 develops the T1 region which is the useless region without the phase difference feature. It is preferred to prevent the development of the T1 region. This can be achieved by adjusting so that the fluid infiltrating through the leak hole into the inside of the container has an ultrasonic signal equivalent to that of P1 (see FIG. 2(A)), thereby enabling the phase delay to increase without an end (i.e., the phase difference increases infinitely). For this purpose, as explained above, in a preferred embodiment of the present invention, there is employed at least one measuring condition selected from the group consisting of the following measuring conditions (i) to (iii):

(i) the waveform of the reference ultrasonic signal is a sine wave;

(ii) the reference ultrasonic signal has a wavelength which is not smaller than the diameter of a smallest leak hole to be detected; and

(iii) at least one of the internal pressure and external pressure of the container is adjusted so that the internal pressure of the container is at least 1 kPa lower than the external pressure of the container.

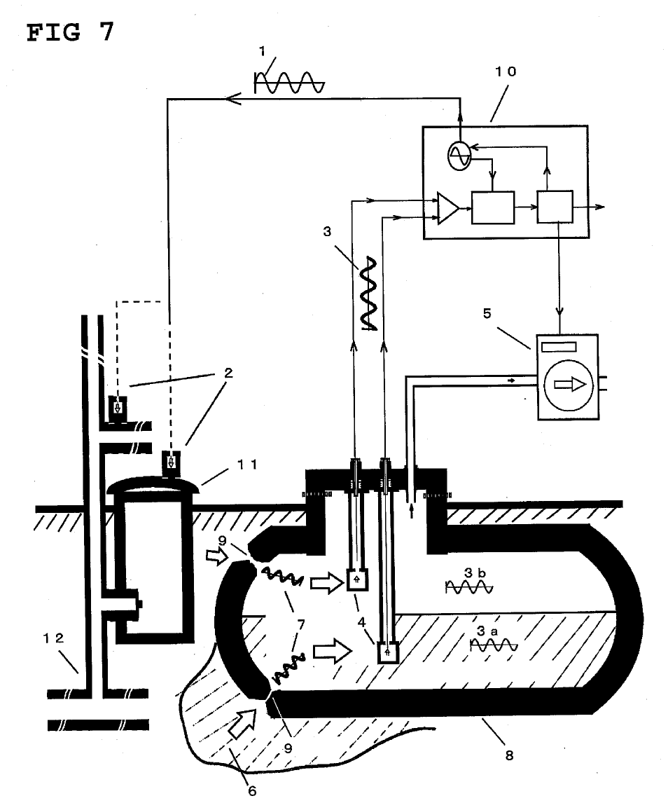

It is more preferred to employ at least two of the above-mentioned measuring conditions, and most preferred to employ all three of the above-mentioned measuring conditions. By employing the above-mentioned measuring conditions, in step (3), it becomes possible to more easily determine whether or not the contained fluid ultrasonic signal 3 has the phase difference feature. Further, for achieving the above-mentioned object, as shown in FIG. 1 and FIG. 7, it is preferred to emit the reference ultrasonic signal 1 from at least one ultrasonic signal emitting element 2 disposed in the outside of the container 8 (specifically, at least one position selected from the group consisting of the outer surface of the container 8 and a vicinity thereof).

The reason why the emission of the reference ultrasonic signal 1 can be performed using the ultrasonic signal emitting element 2 disposed in the outside of the container 8 is that ultrasonic signals are known to exhibit excellent propagation in gas, liquid and solid (such as metal).

As explained above, in the method of the present invention, there is a high degree of freedom for selecting the position to dispose the ultrasonic signal emitting element 2 for generating the reference ultrasonic signal 1 and the ultrasonic signal detecting element 4 for detecting the contained fluid ultrasonic signal 3.

In the case where both the ultrasonic signal emitting element 2 and the ultrasonic signal detecting element 4 are disposed in the inside of the container 8, a skilled person in the art may presume that the present invention poses a problem in that the ultrasonic signal detecting element detects only the reference ultrasonic signal as such emitted from the ultrasonic signal emitting element and does not detect the contained fluid ultrasonic signal and, thus, there cannot be obtained data which show the presence or absence of a leak hole. This presumption is incorrect. The present inventor has fully confirmed, by experiments, that the present invention is free from the above-mentioned problem. This contention is also theoretically substantiated. Through intensive theoretical analyses of the experimental data, the present inventor has presumed that the mechanism of the present invention is as follows. When reference ultrasonic signal 1 is applied to a fluid contained in container 8 having leak hole 9, the reference ultrasonic signal 1 propagates also to fluid 6 around the container 8, thereby applying the reference ultrasonic signal 1 also to the fluid 6 around the container 8. When the fluid 6 around the container 8 infiltrates through the leak hole 9 into the inside of the container 8, the phase of the ultrasonic signal of the infiltrating fluid is changed under the influence of the diameter of the leak hole 9, and the infiltrating fluid flows into the container 8 as a fluid having ultrasonic signal 7 which is different from the reference ultrasonic signal 1. Subsequently, in the inside of the container 8, a waveform synthesis occurs between the reference ultrasonic signal 1 and the ultrasonic signal 7 of the fluid infiltrating through the leak hole 9, to thereby generate a synthesized waveform having the phase difference feature mentioned in step (3) of the method of the present invention. The synthesized waveform propagates throughout the fluid inside the container and is detected as the contained fluid ultrasonic signal 3 mentioned in step (3) of the method of the present invention. Such a mechanism (especially the phase difference feature which is a “continuously increasing phase difference”) is very surprising from prior art, but the present inventor has fully substantiated this mechanism with experimental data and theoretical analyses.

As compared to the conventional leak hole testing methods, the method of the present invention is capable of detecting the presence or absence of a leak hole in a fluid container extremely precisely and rapidly. Further, the method of the present invention is substantially insusceptible to the environmental conditions of the fluid container (e.g., whether the container is of an aboveground type or an underground type, the type of a liquid and/or a gas which is present around the container, and whether or not noises and/or vibrations are present around the container), thereby enabling the presence or absence of a leak hole in a fluid container to be surely determined in any environment. In other words, the degree of freedom for selecting the environment for performing the method of the present invention is very high. This is another, excellent advantage of the present invention over the conventional leak hole testing methods.

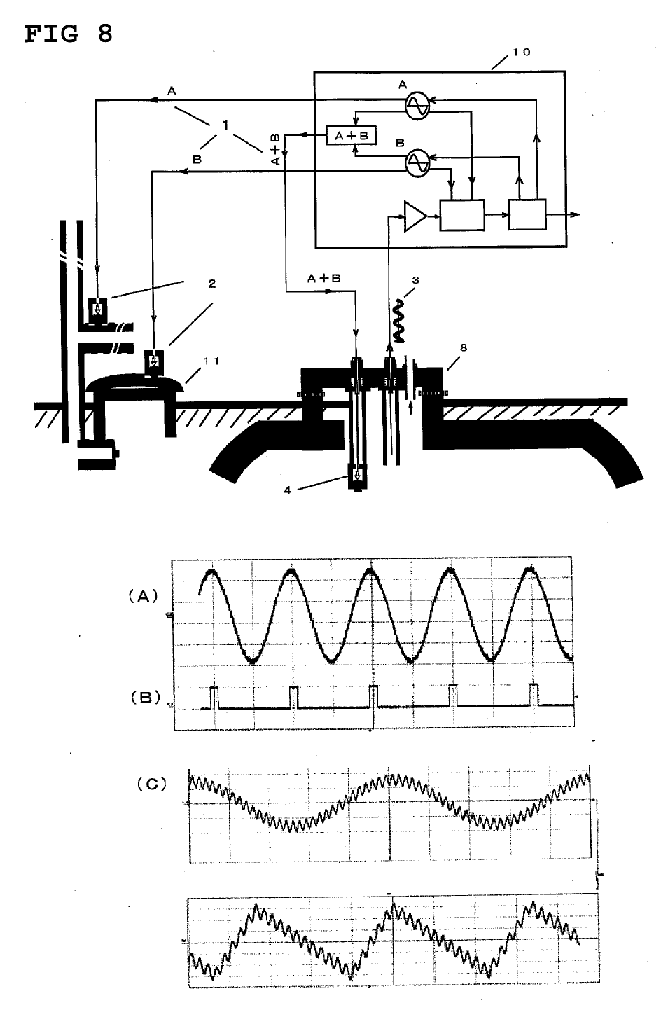

The method of the present invention for testing for the presence of leak hole 9 in fluid container 8 can be practiced easily using the above-mentioned system of the present invention. Examples of operations in which the system of the present invention is practiced on an underground tank of a gas station are shown in FIG. 1, FIG. 7 and FIG. 8. As shown in FIG. 1 and FIG. 7, oil 6 which has leaked from the tank 8 is present around the outer opening of the leak hole 9 of the underground tank 8 of a gas station. Lowering the internal pressure of the tank 8 causes a fluid containing the oil 6 to infiltrate into the inside of the tank 8. In this case, the conventional leak hole testing methods incapable of detecting the infiltrating oil 6 are substantially incapable of detecting the leak hole 9. By contrast, the method of the present invention can surely detect the leak hole 9 while being substantially insusceptible to the type of fluid 6 present around the container 8. Also, the method of the present invention is substantially insusceptible to noises and vibrations which are present around the container 8. Further, the method of the present invention is insusceptible to whether the tank is an aboveground type or an underground type, and is capable of surely detecting the presence of leak hole 9 in either type of tanks. Therefore, the method of the present invention can be used for leak hole testing of substantially all types of tanks (containers).

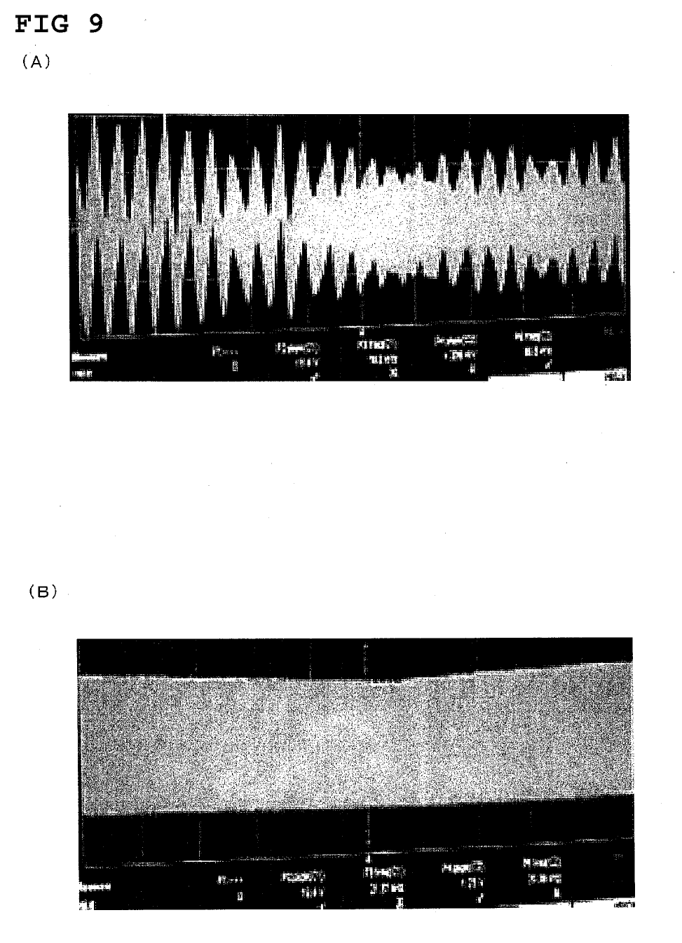

In the case where container 8 has leak hole 9, in step (3) of the method of the present invention, the phase difference feature can be detected from the contained fluid ultrasonic signal 3 within about 10 to 15 minutes from the start of the application of the reference ultrasonic signal 1 to the fluid contained in the container. With respect to the possibility of the occurrence of an error in the detection of the phase difference feature from the contained fluid ultrasonic signal 3, it should be noted that such an error will not occur in the method of the present invention because this method is insusceptible to usual vibrations and the like which may be caused from the outside. For example, during the testing of small container 8 without a leak hole by the method of the present invention, in the case where a strong impact is intentionally applied to the container, the phase and waveform of the contained fluid ultrasonic signal 3 may alter slightly due to the vibrations of the fluid in the container. However, as the vibrations of the fluid cease, the phase will return to and become stationary at approximately the same position as that originally observed before applying the impact to the container. In the case where the fluid in the container is a liquid and a strong impact is intentionally applied to the small container without a leak hole, the only change in the phase and waveform of the contained fluid ultrasonic signal 3 is the generation of vibrations each having a very slow wavelength speed which is only about 1/1000 or less of the reference ultrasonic signal 1, as shown in FIG. 9(B). Therefore, it is most unlikely to erroneously determine such small vibrations as the phase difference feature of the contained fluid ultrasonic signal 3. On the other hand, as shown in FIG. 9(A), in the case where air infiltrates through leak hole 9 (diameter: 0.3 mm) into the small container, the contained fluid ultrasonic signal 3 exhibits rapid vibrations which are completely different from those shown in FIG. 9(B).

If a factor having a possibility of causing an error in the detection of the phase difference feature should be mentioned, there can be mentioned a change in temperature. However, in the case of an underground tank, temperature change is unlikely to occur in its environment and has been confirmed to be in an ignorable range. Therefore, there is no need to take the temperature change into consideration.

In the case of an aboveground tank, the range of temperature change occurring under normal conditions for using the measuring apparatuses will not be a problem. A temperature change which may influence the outcome of the testing is a continuous external application of temperature change which causes either a smooth elevation or lowering of the temperature of the tank. Therefore, testing conditions should be chosen so as to prevent the tank from being exposed to strong direct rays of sunlight or to the warm air current of a stove or an air conditioner. There is no problem as long as the method of the present invention is practiced under normal working conditions which enable workers to operate the apparatuses appropriately and to process the test results appropriately.

Anyway, the law strictly prescribes that the measuring apparatuses and systems authorized for use in fields which employ hazardous materials (such as fuel) must exhibit performances sufficient for ensuring the expected results. Therefore, in the case where the method of the present invention is used in such fields, accurate test results will be obtained as long as an operator, who is a person skilled in the art, operates the related apparatuses and systems with due care without violating the related laws.

Important points to be noticed will be explained herein.

One of the most important objects of the present invention is to perform the leak hole testing of a tank containing a hazardous material with accuracy and safety. Therefore, when a person intends to manufacture or remodel an apparatus or to perform various experimental operations based on the descriptions of the present specification, close attention must be paid to the fact that, as a first step before making any action, the person must take the below-mentioned explanation into consideration and make contact with relevant authorities or organizations for obtaining an approval for using the apparatuses, an approval as a hazardous materials handler, or both.

Based on the descriptions of the present specification, it is possible to design and manufacture apparatuses which are satisfactory for use in places where hazardous materials containers are handled. However, even when the designer, manufacturer, operator and the like are different, all of the designer, manufacturer and operator should bear in mind that they inevitably bear a large responsibility as a skilled person working in the field handling hazardous materials. This applies to not only the cases where the present invention is practiced directly by a skilled person working in the field handling hazardous materials, but also the cases where the present invention is practiced by a non-skilled person under direct or indirect supervision of a skilled person. In the case where the present invention is put into practice in the field handling hazardous materials, all people involved must strictly follow all of the relevant laws and the like, and utmost importance should be placed on ensuring safety. This is a matter of course for a person skilled in the art, but by way of precaution, it is described herein for preventing the occurrence of serious emergency accidents due to carelessness.

An example of the construction of the system of the present invention will be shown below. Explanations will be made so that design, production and evaluation of the system apparatus can be satisfactorily performed by an engineer having a technical level for performing an operation check on an apparatus by using an oscilloscope or the like. Therefore, a system apparatus which is experimentally produced based on the below-mentioned explanations can exhibit a satisfactory performance for experimental and practical purposes. However, from the viewpoint of securing safety, a fluid which is used for experiments using the system of the present invention should be only water and/or air. Any hazardous material (such as a burnable liquid (e.g., an oil or an alcohol), a burnable gas (e.g., a gaseous fuel), liquid nitrogen, a liquid chemical substance, or a gaseous chemical substance) should not be used as a fluid. Further, needless to say, when adjustment or the like of a circuit is performed at a place near water, care needs to be taken so as to prevent an electric shock, since ordinary water exhibits electrical conductivity.

All apparatuses which are procured for producing the system need to be of an explosion-proof type. The below-mentioned examples of apparatuses are for general use, and hence can be used with air as a fluid. When water is used as a fluid, it is necessary for the apparatuses to be of a water-proof type. Usually, a water-proof type of an apparatus and an explosion-proof type of an apparatus are considered as being of special specifications. It should be noted that the below-mentioned examples of apparatuses are for general use and can be used only in air.

A pressure value control means is used for discharging a part of the fluid contained in the container to thereby decompress the inside of the container. When the inside of the container is decompressed, a part of the fluid (a liquid and/or a gas) contained in the container is sucked out therefrom and introduced into a decompressor and is further discharged therefrom to the outside. Therefore, it is necessary to take care to ensure that the discharged fluid does not adversely affect the environment. For example, when practical apparatuses are operated on a practical container containing a hazardous material, the operator should be very careful that the hazardous material (such as a liquid fuel and/or a gaseous fuel) which is discharged out of the container is dealt with appropriately.

One of the most important objects of the present invention is to protect the safety of public society in respect of the handling of hazardous materials. Therefore, the operation of a system, apparatuses and the like which are used for attaining such object of the present invention must be performed so as never to cause a dangerous accident. Further, it should be noted that, if the present invention is practiced in an erroneous fashion, thus leading to an erroneous judgment about the presence or absence of a leak hole, it is possible that the erroneous judgment becomes a cause of a serious accident or an environmental pollution, such as pollution of underground earth or pollution of underground water. In the production or procurement of a system, apparatuses and the like which are used for practicing the present invention, reliability and safety should take first place, and economy and ease to design and produce should take second place. For attaining the most important object of the present invention, i.e., protection of the safety of public society in respect of the handling of hazardous materials, needless to say, the apparatuses used for practicing the present invention are required to satisfy high level of reliability and safety (for example, explosion-proof property and water-proof property) which are required of testing and judging apparatuses, as compared to the ordinary level of reliability and safety which are required of ordinary measuring apparatuses. In view of the most important object of the present invention (i.e., protection of the safety of public society in respect of the handling of hazardous materials), and from the viewpoint of preventing the occurrence of the above-described safety problems, the present inventor is ready to give responsible cooperation (such as technical advice and guidance) to a honest skilled person in the art who wishes to conduct research, experimentation and implementation of the system and apparatuses which are used for practicing the present invention.

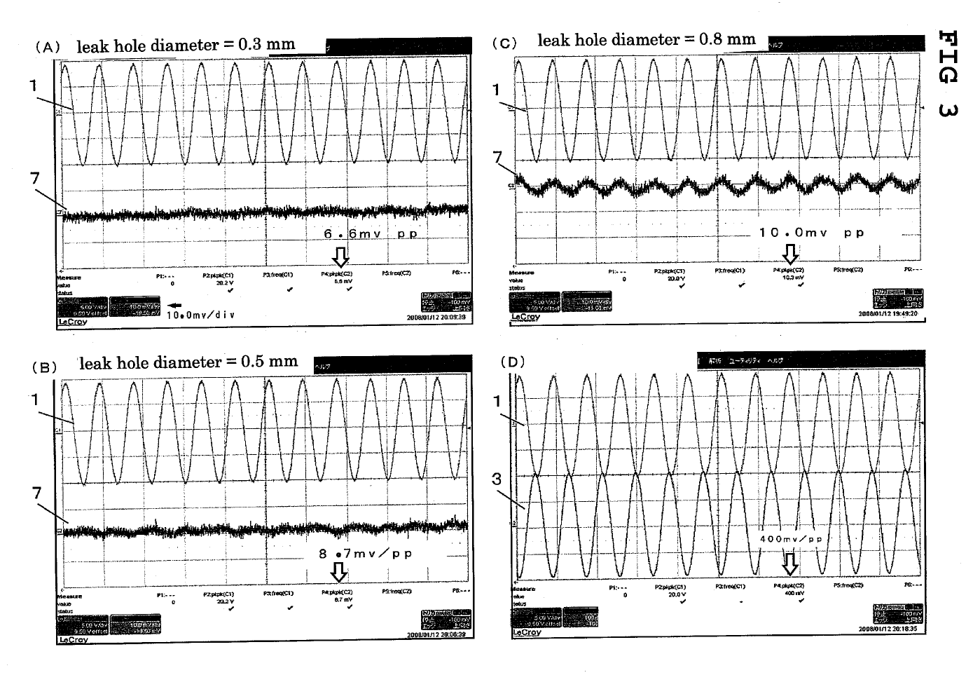

With respect to the reference ultrasonic signal 1 which has been modified so that the phase difference feature can be more easily observed, an explanation will be made with reference to FIGS. 2 and 3 which show photographs of waveforms observed using an oscilloscope. As mentioned above, it is preferred to employ a measuring condition such that the phase delay of the contained fluid ultrasonic signal 3 continues to increase infinitely (that is, the phase difference continues to increase infinitely). For this purpose, the above-mentioned measuring conditions (i) to (iii) are useful. Of the measuring conditions (i) to (iii), the measuring condition (ii) (the reference ultrasonic signal has a wavelength which is not smaller than the diameter of a smallest leak hole to be detected) is especially useful. In the case where the measuring condition (ii) is used, when a fluid 6 (to which a reference ultrasonic signal 1 has been applied) in the outside of the container 8 is caused to infiltrate into the container 8 through a leak hole 9, the phase of the ultrasonic signal of the infiltrating fluid is necessarily changed under the influence of the diameter of the leak hole 9, so that the ultrasonic signal 7 of the infiltrating fluid does not have a phase which is the same as or close to the phase of the reference ultrasonic signal 1. For example, theoretically, when the diameter of the leak hole 9 is ¼ of the wavelength of the reference ultrasonic signal 1, the ultrasonic signal 7 of the fluid infiltrating into the container 8 through the leak hole 9 is caused to have a phase which exhibits a maximum delay of 90 degrees. (Such optimum ultrasonic signal 7 of the infiltrating fluid can be expressed as an “ultrasonic signal 7 which has not only a minimum amplitude capable of generating a waveform, but also a maximum value of phase delay”.) By using such optimum ultrasonic signal 7 of the infiltrating fluid, the contained fluid ultrasonic signal 3 can be caused to have a large phase difference from the reference ultrasonic signal 1. By continuing to decompress the inside of the container 8, a fluid having the above-mentioned optimum ultrasonic signal 7 continues to infiltrate into the container 8 through the leak hole 9, so that the phase difference of the contained fluid ultrasonic signal 3 from the reference ultrasonic signal 1 continues to increase.

At present, it is legally specified that the diameter of a leak hole 9 which is required to be detected is 0.3 mm or more. FIG. 3(A) shows the results of an operation in which the wavelength of a reference ultrasonic signal 1 is modified to thereby adjust the phase of the ultrasonic signal 7 of a fluid flowing through a leak hole 9 so as to achieve an optimum effect when the leak hole diameter is 0.3 mm. FIG. 3(B) shows the ultrasonic signal 7 of a fluid flowing through a leak hole 9 in the case where the leak hole diameter is 0.5 mm. FIG. 3(C) shows the ultrasonic signal 7 of a fluid flowing through a leak hole 9 in the case where the leak hole diameter is 0.8 mm. With respect to each of FIGS. 3(A) to 3(C), the ultrasonic signal 7 of a fluid flowing through a leak hole was obtained by a method (as shown in FIG. 10(A)) for adjustment and evaluation of a leak hole testing system, wherein a fluid is withdrawn from the inside to the outside of the container 8 through a leak hole 9, and the ultrasonic signal of the withdrawn fluid is detected by an ultrasonic signal detecting element 4 disposed in the outside of the container 8.

For reference, FIG. 3(D) shows a contained fluid ultrasonic signal 3 in the case where there is no leak hole 9. In this case, the contained fluid ultrasonic signal 3 is almost the same as the reference ultrasonic signal 1.

When the infiltration of a fluid into the container 8 does not continue or occurs intermittently because the diameter of the leak hole 9 is too small, there is observed a phenomenon in which the phase difference once stops at a certain value and then starts to increase again. In such case, it is desired to increase the degree of pressure reduction in the inside of the container 8, thereby increasing the force for causing an outside fluid to infiltrate into the container 8.

There is an upper limit for the degree of pressure reduction in the inside of the container 8. In view of the mechanical strength and the like of the container 8, in general, the degree of pressure reduction in the inside of the container 8 is preferably about −25 kPa or smaller, more preferably from −20 kPa to −15 kPa, still more preferably about −5 kPa. When the diameter of the leak hole 9 is 0.3 mm, the smallest possible degree of pressure reduction is from about −1 kPa to about −2 kPa.

An explanation will be made on the waveform of the reference ultrasonic signal 1. In the physical theory, a sine wave is most stable in activity. In general, the phase difference feature in the present invention is most stable when the waveform of the reference ultrasonic signal 1 is a sine wave. Therefore, generally, it is preferred that the waveform of the reference ultrasonic signal 1 is a sine wave. However, in the case of an ordinary measurement or the like, the use of a rectangular wave or a pulse wave (as shown in FIG. 8(B)) gives many advantages in that observation and measurement of the phase of these waves is easier, and that a signal processing unit for these waves is more simple and smaller and can be obtained at a lower cost. A complex wave (as shown in FIG. 8(C)) which is obtained by complexing of a plurality of waves having different wavelengths, is advantageous in that a complex wave can be suitably used with a broad range of diameter of the leak hole 9 in accordance with the relationship between the diameter of the leak hole 9 to be detected and a preferred wavelength of the reference ultrasonic signal 1. The characteristics of a sine wave and the characteristics of a rectangular wave or a pulse wave (as shown in FIG. 8(B)), may be altered. Further, a pulse wave as shown in FIG. 8(B) is advantageous in that the wavelength can be decreased without changing the frequency, so that a pulse wave is suitable for coping with a smaller diameter of the leak hole 9. As shown in FIG. 8, a combination of the wavelength (frequency) and waveform of a signal can be automatically adjusted while observing the signal waveform by means of a microcomputer.

Each of FIG. 10(B) and FIG. 10(C) shows an operation in which the method of the present invention is practiced for testing for the presence of a leak hole 9 by using a tank for evaluation/experimentation and simulated leak holes (as shown in FIG. 10(D)) used for evaluation of a leak hole testing method. Each of FIGS. 4 to 6 shows a picture sequence which has been prepared by a method in which the display of an oscilloscope being used for observing the operation shown in each of FIG. 10(B) and FIG. 10(C), is continuously recorded by means of a video camera; static images showing the phase difference feature are taken from the resultant video record; and the static images are arranged in accordance with the lapse of observation time to thereby obtain a picture sequence.

FIG. 4 shows a picture sequence obtained from the video record showing the phase difference feature observed in the case where the leak hole 9 has a diameter of 1.0 mm. From FIG. 4, there can be observed a phenomenon in which the phase difference feature occurs, i.e., the phase difference continues to crease, and also a characteristic phenomenon in which the continuous increase in phase difference necessarily results in the occurrence of a change in amplitude.

FIG. 5 shows a picture sequence obtained from the video record showing the phase difference feature observed in the case where the leak hole 9 has a diameter of 0.3 mm. From FIG. 5, as in the case of FIG. 4, there can be observed a phenomenon in which the phase difference feature occurs, i.e., the phase difference continues to crease, and also a characteristic phenomenon in which the continuous increase in phase difference necessarily results in the occurrence of a change in amplitude. The difference between the data of FIG. 4 (diameter of leak hole 9: 1.0 mm) and the data of FIG. 5 (diameter of leak hole 9: 0.3 mm) resides only in the time value concerning the increase in phase difference.

FIG. 6 shows a picture sequence obtained from the video record showing that the characteristic phenomenon of a phase inversion occurs around a phase difference of 180 degrees in the case where the leak hole 9 has a diameter of 1.0 mm. Also the data of FIG. 5 (diameter of leak hole 9: 0.3 mm) show that the characteristic phenomenon of a phase inversion occurs around a phase difference of 180 degrees.

Hereinabove, the phase difference feature and other characteristic phenomena which necessarily result from the phase difference feature have been explained with reference to the case where the leak hole 9 has a diameter of 1.0 mm and the case where the leak hole 9 has a diameter of 0.3 mm. In addition, it has been confirmed that substantially the same results as described above can also be obtained even when experiments are performed in which there are individually employed leak holes 9 respectively having diameters of 0.8 mm, 1.5 mm and 2.0 mm. Therefore, it has been confirmed that, when the container has a leak hole 9, the phase difference feature and the characteristic phenomenon of a phase inversion (occurring around a phase difference of 180 degrees) necessarily occur in the method of the present invention.

In FIG. 10, there are shown operations in which experiments and measurements concerning the present invention are performed using a method which has been conventionally appreciated for good performance in adjustment and evaluation of a leak hole testing system. FIG. 10(A) shows an example of a method for adjusting the wavelength or the like of a reference ultrasonic signal 1 in accordance with the diameter of a leak hole 9 to be detected. FIG. 10(B) shows a method for evaluating the method of the present invention with respect to a case where only a small amount of a liquid 6 resides in the outside of a container 8, and all residing liquid 6 is present just around an outer opening of a leak hole 9. FIG. 10(C) shows a method for evaluating the method of the present invention with respect to a case where a large part of the outer surface of an underground tank 8 is placed in contact with a residing fluid 6, such as in the case of a coastal area, a river front or the like. FIG. 10(D) shows simulated leak holes 9 used for evaluation of a leak hole testing method.

As shown in FIG. 7, in accordance with the situation of the site at which the method of the present invention is practiced, for example, the ultrasonic signal emitting element 2 may be disposed in any of another tank (not shown) positioned adjacent to the tank 8 to be subjected to the leak hole testing, an underground manhole 11, and an underground pipe 12. Each of the ultrasonic signal emitting element 2 and the ultrasonic signal detecting element 4 can be independently disposed in at least one position selected from the group consisting of the outside of the container 8 and the inside of the container 8. When any of the ultrasonic signal emitting element 2 and the ultrasonic signal detecting element 4 is disposed in the outside of the container 8, it may be disposed either in contact with or not in contact with the outer surface of the container 8. Also, when any of the ultrasonic signal emitting element 2 and the ultrasonic signal detecting element 4 is disposed in the inside of the container 8, it may be disposed either in contact with or not in contact with the inner surface of the container 8.

Hereinbelow, explanation is given, referring to examples, on a method for assembling the system of the present invention, and ultrasonic signal emitting element 2, ultrasonic signal detecting element 4, pressure value control means 5, and electronic processing means 10 for generation and processing of electrical signals, each of which is used in the system of the present invention, as well as a method for the determination of the presence of the above-mentioned phase difference feature.

Ultrasonic signal emitting element 2 and ultrasonic signal detecting element 4 can be chosen from a number of commercially available elements, even if it is intended to use the elements in the state of being contacted with a liquid.

As ultrasonic signal emitting element 2, a variety of ultrasonic signal emitting sensors and the like, which are sold by manufacturers, can be most appropriately used. Examples of commercially available ultrasonic signal emitting elements 2 include UT200LF8 and UT200BA8 (each manufactured and sold by Murata Manufacturing Co., Ltd., Japan), each of which can be used for both transmission and reception of signals.

As ultrasonic signal detecting element 4, a number of ultrasonic signal receiving sensors, AEvibration sensors, acceleration sensors and the like, which are sold by manufacturers, can be most appropriately used. Examples of commercially available ultrasonic signal detecting elements 4 include 393C (earth and insulation) (manufactured and sold by TOYO Corporation, Japan).

As pressure value control means 5 for pressure reduction or elevation, there can be used general-purpose products, such as commercially available products provided by manufacturers. Examples of commercially available pressure value control means 5 include DA-40S (manufactured and sold by ULVAC KIKOU Inc., Japan).

As an electrical signal generator for emitting a reference ultrasonic signal, which is connected to ultrasonic signal emitting element 2, there can be used those which are sold by manufacturers of measuring instruments. Examples of commercially available electrical signal generators include SG-4105 (manufactured and sold by IWATSU ELECTRIC CO., LTD., Japan).

A processing circuit for measured signals, which is connected to ultrasonic signal detecting element 4, and a method for the determination of the presence of the phase difference feature, are explained below.

As a processing circuit for measured signals, there can be used a receiving circuit which is produced with reference to examples of receiving circuits recommended and/or proposed by manufacturers of ultrasonic signal detecting elements 4 to be used. Reference ultrasonic signal 1 to be compared with contained fluid ultrasonic signal 3 can be obtained as follows. Reference ultrasonic signals 1 emitted from the electrical signal generator are supplied to ultrasonic signal emitting element 2, wherein a part of the reference ultrasonic signals 1 are ramified using a resistance split circuit and the ramified signals are used as reference ultrasonic signal 1 to be compared with contained fluid ultrasonic signal 3.

As mentioned above, the measured signal (contained fluid ultrasonic signal 3) obtained from ultrasonic signal detecting element 4 has the feature that it is substantially insusceptible to noise signals, temperatures, or vibrations occurring in the outside of the container. Therefore, the construction of a processing circuit for measured signals can be selected with a high degree of freedom, and a required degree of amplification and a satisfactory S/N ratio can be easily obtained. Receiving circuits and processing circuits for measured signals can be easily designed and assembled. Examples of receiving circuits and processing circuits and assembly thereof are given below.

A receiving circuit for ultrasonic signal detecting element 4 can be easily assembled with reference to the circuits or their specifications recommended by the manufacturers. The output signals from the thus-assembled receiving circuit and the output signals from the generator for reference ultrasonic signal 1 are connected to the input terminal of a phase measuring circuit. The phase difference between reference ultrasonic signal 1 and the receiving signal (contained fluid ultrasonic signal 3) is indicated by the value output from the phase measuring circuit. This value is input into an operation processing circuit (e.g., a microcomputer) to evaluate the phase difference. Based on the evaluation, the presence or absence of the phase difference feature is determined, and the presence or absence of leak hole 9 is judged.

The evaluation of the phase difference by using a phase measuring circuit and an operation processing circuit can be made, for example, as follows. The two types of output signals (i.e., the output signal from the receiving circuit and the output signal from the generator for reference ultrasonic signal 1) whose phases are to be measured are input into two A/D converters to obtain outputs, and the outputs are read using a microcomputer. By observing the change of the phases of the two types of signals with the lapse of time, the judgment of the presence of the phase difference feature can be easily made using simple electronic circuits and simple operation programs.

As another specific example of a method for evaluating the phase difference, the following method can be mentioned. The two types of signals whose phases are to be measured are input into a commercially available analogue comparator IC. The time width of the digital signal waveform output from the analogue comparator IC indicates the difference between the phases of the two types of signals. Therefore, when the two types of signals are input into a pulse width counter, which is easily assembled by using a commercially available digital IC, the phase difference is converted with high precision to a digital time value, which is output. This time value is input into a display device, such as a commercially available 7-segment display element. If the time value displayed remains constant, this means that the phase difference remains constant, and it is judged that there is no leak hole. On the other hand, if the time value displayed continues to change, this means that the phase difference increases, wherein the increase in the phase difference corresponds to the change of the time value. Therefore, the presence of the phase difference feature can be judged on the basis of the change of the time value. The minimum time value displayed is zero, and the maximum time value displayed indicates the time value corresponding to one half of the wavelength of reference ultrasonic signal 1, which also corresponds to a phase difference of 180 degrees. Since there is a linear relationship between the phase difference and the time value displayed, the time value can be easily converted to the phase difference to make an evaluation in terms of angle, as explained below. If the time value displayed is zero at a phase difference of zero, the time value attains its maximum at a phase difference of 180 degrees. On the other hand, if the time value displayed attains its maximum at a phase difference of zero, the time value is zero at a phase difference of 180 degrees. The relationship between the phase difference and the time value displayed also varies depending on the polarity connected to the receiving circuit and the like. The polarity can be selected by exchanging the positive and negative input terminals of the analogue comparator IC.

The presence of the phase difference feature can be determined as follows. Reference ultrasonic signals 1 emitted from the electrical signal generator are supplied to ultrasonic signal emitting element 2, wherein a part of the reference ultrasonic signals 1 are ramified using a resistance split circuit and the resultant ramified signals are used as reference ultrasonic signal 1 to be compared with contained fluid ultrasonic signal 3. As the electrical signal generator, commercially available ones mentioned above can be used. The phase difference between reference ultrasonic signal 1 and the measured signal (contained fluid ultrasonic signal 3) obtained from ultrasonic signal detecting element 4 is measured for a period of about 15 minutes from the start of the measurement, and the change of the phase difference during this period is evaluated. The period of the measurement can be appropriately adjusted, considering a period of about 15 minutes as a reference.

More particularly, measuring instruments are installed for the preparation of the measurement, and the mouth of the container is closed. Then, an operation for obtaining contained fluid ultrasonic signal 3 is initiated by emitting reference ultrasonic signal 1 having a predetermined phase to the fluid contained in the container while reducing the internal pressure of the container using a pressure reduction device. When the internal pressure of the container is reduced to a predetermined value, the operation of the pressure reduction device is ceased, and the inside of the container is allowed to stand still for about 1 to 3 minutes so that the vibration of the fluid in the container caused by the pressure reduction becomes stable and subsides. By this time, each of the amplitude difference and phase difference between reference ultrasonic signal 1 and the measured signal (contained fluid ultrasonic signal 3) reaches a specific value.

If container 8 has no leak hole 9, there is no longer any change in the amplitude difference or phase difference. On the other hand, if container 8 has a leak hole 9, the phase difference begins to increase gradually. Examples of experimental results of the phase difference when there is a leak hole are given in FIGS. 4 and 5. In the case of FIG. 4, leak hole 9 has a diameter of 1.0 mm, and the phase difference becomes about 90 degrees in about 10 seconds. On the other hand, in the case of FIG. 5, leak hole 9 has a diameter of 0.3 mm, and the phase difference becomes about 90 degrees in about one minute and 30 seconds. With reference to the experimental results shown in FIGS. 4 and 5, an appropriate evaluation of the phase difference can be made. If the phase difference continues to increase with the lapse of time as shown in FIGS. 4 and 5, it is judged that contained fluid ultrasonic signal 3 has the phase difference feature. Usually, if the change of the phase difference can be observed until the phase difference increases to 15 degrees or more, there is substantially no possibility of misjudgment. However, in view of the possibility that the environment around the site where tank 8 is tested may give the measurement more influence than expected, it is preferred that the observation is continued until the phase difference increases to 45 degrees or more. If the observation is continued until the phase difference increases to 90 degrees or more, there is absolutely no possibility of misjudgment, unless the measuring instruments or test system has serious defects.

With respect to the size of container 8 to which the test method of the present invention is applied, there is no particular limitation. By the method of the present invention, a testing for the presence of a leak hole can be performed with respect to a wide variety of containers of various volumes, dimensions and shapes employed in various fields of industry, the containers ranging from a small size container (e.g., a container of about a 1-liter volume) which can be placed on the palm, to a gigantic container (e.g., a container of about a 15,000-kiloliter volume) which is generally called a “tank”. In the most representative case, tank 8 to which the test method of the present invention is applied has a volume of about 500 to 3,000 kiloliters.

Common examples of tanks 8 which are legally required to be subjected to leak hole testing include tanks carried on tank lorries. A tank carried on a tank lorry has a diameter of about 2 m. The length of such tank varies depending on the volume thereof, and, for example, ranges from 3 m to 20 m or more. In a representative case, the tank has a shape of cylinder. With respect to the dimension and shape of underground tanks, the same explanation as given above in connection with tanks carried on tank lorries applies. The volume, dimension and shape of a tank greatly varies depending on the type of the factory or facilities in which the tank is installed, the type of the fluid contained in the tank, and the amount of the fluid. The presence of a leak hole in any tank can be precisely judged by the method of the present invention.

### INDUSTRIAL APPLICABILITY

The testing method of the present invention is advantageous not only in that the presence or absence of a leak hole in a fluid container can be determined extremely precisely and rapidly, but also in that the method of the present invention is substantially insusceptible to the environmental conditions of the fluid container (e.g., whether the container is of an above-ground type or an underground type, the type of a liquid and/or a gas which is present around the container, and whether or not noises and/or vibrations are present around the container), thereby enabling the presence or absence of a leak hole in the fluid container to be surely determined in any environment. Therefore, the method of the present invention has very high reliability and very high efficiency. By the method of the present invention, a testing for the presence of a leak hole can be performed with high precision and high efficiency with respect to a wide variety of containers of various volumes, dimensions and shapes employed in various fields of industry, the containers ranging from a small size container (e.g., a container of about a 1-liter volume) which can be placed on the palm, to a gigantic container (e.g., a container of about a 15,000-kiloliter volume) which is generally called a “tank”. In the prior art, the detection ratio of leak holes in the bottom portions of underground tanks is very low, although it is considered that a leak hole is most likely to occur in the bottom portion of an underground tank. By the method of the present invention, the infiltration of an oil into the inside of a tank can be surely detected, thereby enabling a leak hole in the bottom portion of an underground tank to be surely detected. Therefore, the method of the present invention has for the first time fully attained the object of the legally required leak hole testing of a tank, thereby making a great contribution to the safety of public society in respect of the handling of hazardous materials.

1-6. (canceled)

7. A method for testing for the presence of a leak hole in a fluid container, comprising:
(1) closing a mouth of a container containing at least one fluid selected from the group consisting of a liquid and a gas,
(2) adjusting at least one of the internal pressure and external pressure of said container so that the internal pressure of said container is lower than the external pressure of said container, and applying a reference ultrasonic signal having a predetermined phase to said fluid contained in said container, to thereby obtain a contained fluid ultrasonic signal, and
(3) comparing said reference ultrasonic signal and said contained fluid ultrasonic signal with each other, wherein, when said contained fluid ultrasonic signal has a phase difference from said reference ultrasonic signal, and said phase difference continues to increase with the lapse of time, said container is judged to have a leak hole.

8. A method for testing for the presence of a leak hole in a fluid container, comprising:
(1) closing a mouth of a container containing at least one fluid selected from the group consisting of a liquid and a gas,
(2) adjusting at least one of the internal pressure and external pressure of said container by using a pressure value control means so that one of the internal pressure and external pressure of said container is lower than the other, applying a reference ultrasonic signal having a predetermined phase to said fluid contained in said container by using at least one ultrasonic signal emitting means disposed in at least one position selected from the group consisting of the outside and inside of said container, to thereby obtain a contained fluid ultrasonic signal, and detecting said contained fluid ultrasonic signal by using at least one ultrasonic signal detecting means disposed in at least one position selected from the group consisting of the outside and inside of said container, and
(3) comparing said reference ultrasonic signal and said contained fluid ultrasonic signal with each other, wherein, when at least one condition selected from the group consisting of the following 3 conditions (α) to (γ):
(α) said contained fluid ultrasonic signal has a phase difference from said reference ultrasonic signal, and said phase difference continues to increase with the lapse of time;
(β) said contained fluid ultrasonic signal exhibits a phase inversion; and
(γ) said contained fluid ultrasonic signal exhibits a change in amplitude with the lapse of time,
is satisfied, said container is judged to have a leak hole.

9. The method according to claim 7 or 8, wherein the wavelength of said reference ultrasonic signal is adjusted to a value which is not smaller than the diameter of a smallest leak hole to be detected.

10. The method according to claim 7 or 8, wherein said container is a tank selected from the group consisting of an aboveground tank, an underground tank, a stationary tank and a mobile tank, and said container has at least one member selected from the group consisting of an inlet pipe, an exhaust pipe, a maintenance pipe, a connection pipe, and another container which is connected to said container through a pipe.
